(19) United States
(12) Patent Application Publication
(10) Pub. No.: US 2024/0342725 A1
(43) Pub. Date: Oct. 17, 2024

(54) PORTABLE THERMAL BLOCK MODULE

(71) Applicant: KOREA ELECTRONICS TECHNOLOGY INSTITUTE, Seongnam-si (KR)

(72) Inventors: Seong Eun KIM, Seoul (KR); Seo Eun LEE, Seoul (KR)

(21) Appl. No.: 18/754,816

(22) Filed: Jun. 26, 2024

Related U.S. Application Data
(63) Continuation of application No. PCT/KR2022/021508, filed on Dec. 28, 2022.

(30) Foreign Application Priority Data
Dec. 30, 2021 (KR) 10-2021-0192349

(51) Int. Cl. B01L 7/00

(52) U.S. Cl. CPC B01L 7/00; B01L 2200/147; B01L 2300/041; B01L 2300/1805

(57) ABSTRACT

Proposed are a portable thermal block module, a temperature variable system for a reaction vessel comprising same, and an on-site analysis device comprising same. The portable thermal block module may include a heating element, a thermal block stacked on the heating element, and a fixed unit. The thermal block may include a substrate and one or more bodies. The one or more bodies may be located on the substrate so as to be spaced apart from each other. Each body may include an insertion recess so that at least a portion of a reaction vessel can be inserted therein. The substrate and the bodies may be made of a thermally conductive material.

### CROSS REFERENCE TO RELATED APPLICATIONS

This is a continuation application of International Patent Application No. PCT/KR2022/021508, filed on Dec. 28, 2022, which claims priority to Korean Patent Application No. 10-2021-0192349 filed on Dec. 30, 2021, contents of each of which are incorporated herein by reference in their entireties.

### BACKGROUND

### Technical Field

The present disclosure relates to a thermal block module, and more particularly to a portable thermal block module, a temperature variable system for reaction vessels including the same, and an on-site analysis device including the same.

### Description of Related Technology

Diagnostic testing, such as determining the presence or absence of a particular disease, typically involves a chemical and/or biological reaction experiment of a sample collected from a subject in a reaction vessel, such as a test tube. In such a chemical and/or biological reaction experiment, temperature is one of the critical variables. In one particular exemplary reaction experiment, a temperature of about 30° C., not room temperature, may be the temperature at which reaction activity is optimized.

### SUMMARY

One aspect is a portable thermal block module suitable for use in the field and an on-site analysis device including the same.

Another aspect is a portable thermal block module including a heating element, a heat block stacked on the heating element, the heat block including a substrate and one or more bodies, the one or more bodies being located on the substrate so as to be spaced apart from each other, each of the bodies including an insertion recess configured to allow at least a part of a reaction vessel to be inserted thereinto, each of the substrate and the bodies being made of a thermally conductive material, and a fixing unit.

According to one embodiment of the present disclosure, the heating element may be a planar heating element.

According to one embodiment of the present disclosure, the heat block may include 1 to 2000 bodies.

According to one embodiment of the present disclosure, each of the thinnest part of each body and the substrate may have a thickness of 0.1 to 1 mm.

According to one embodiment of the present disclosure, the portable thermal block module may further include a sensor, when the heat block includes two or more bodies, the sensor may be located on the substrate between the at least two bodies so as to be spaced apart from the bodies.

According to one embodiment of the present disclosure, the fixing unit may include a first fixing unit and a second fixing unit, and a part of the first fixing unit and a part of the second fixing unit may directly or indirectly contact each other to fix the heating element and the heat block between the first fixing unit and the second fixing unit.

Another aspect is a temperature variable system for reaction vessels, the temperature variable system including two or more thermal block modules, each of the thermal block modules being the portable thermal block module according to the first aspect, a support unit configured to support the thermal block modules, a chamber unit configured to allow a set of reaction vessels to be mounted therein, the set of reaction vessels including a plurality of reaction vessels, the number of the reaction vessels being less than or equal to the number of the bodies of one of the thermal block modules, and a rotating shaft, the rotating shaft being connected to the support unit and the chamber unit such that, when the rotating shaft rotates in one direction, the support unit moves downward and the chamber unit rotates, and when the rotating shaft rotates in the opposite direction, the support unit moves upward.

According to one embodiment of the present disclosure, the temperature variable system may further include a rotation guide unit connected to the rotating shaft and the chamber unit, the rotation guide unit being configured to guide rotation of the chamber unit.

A third aspect of the present disclosure relates to an on-site analysis device including the portable thermal block module according to the first aspect or the temperature variable system for reaction vessels according to the second aspect.

The thermal block module and the analysis device of the present disclosure are portable for use in the field and are capable of maintaining a stable optimum temperature, especially in the field where temperature change is extremely drastic.

### BRIEF DESCRIPTION OF THE DRAWINGS

FIG. 1 is a perspective view of a heat block according to one embodiment of the present disclosure.

FIG. 2 is a perspective view of the heat block and a heating element according to one embodiment of the present disclosure.

FIG. 3 is an exploded view of the heat block, the heating element, and a first fixing unit according to one embodiment of the present disclosure.

FIG. 4A is a perspective view of a thermal block module according to one embodiment of the present disclosure.

FIG. 4B is an exploded view of the thermal block module of FIG. 4A.

FIG. 5 is a graph of time versus temperature according to one experimental example of the present disclosure.

FIG. 6 is a graph of temperature versus absorbance according to one experimental example of the present disclosure.

FIGS. 7 and 8 are graphs of time versus temperature according to one experimental example of the present disclosure.

### DETAILED DESCRIPTION

In order to provide an optimized temperature on diagnostic testing, it is common to use a heat block (also referred to as a heating block) in a lab (a laboratory). The heat block may be provided with a well configured to receive a plurality of reaction vessels, and the heat block functions to provide constant heat to the reaction vessels, thereby assisting the reaction experiment to be performed at the optimized temperature.

Today, there is growing interest in on-site diagnostic testing, where a sample collected from a subject can be directly diagnosed in the field before being transported to the lab. In the field, however, it is difficult to control the temperature, which is a variable that has a significant influence on the results of the testing, constant. In the case of a conventional heat block, there are problems such as heavy weight, e.g., a weight of more than 1 kg, and a wired power supply manner, which limits use in the field and is inconvenient.

Meanwhile, there are cases where temperature changes are required in analysis, such as polymerase chain reaction (PCR), which includes a plurality of steps with different suitable temperature ranges for denaturation, annealing, and polymerization. When using the conventional heat block, a significant time is required to change from a first temperature to a second temperature, which affects reduction in reaction efficiency, reproducibility, reliability, etc. as well as an increase in the overall analysis time.

The object, specific advantages, and novel features of the present disclosure will become apparent from the following detailed description and preferred embodiments in connection with the accompanying drawings, but the present disclosure is not necessarily limited thereto. Furthermore, in describing the present disclosure, a detailed description of the related known art will be omitted when the same may obscure the subject matter of the present disclosure.

### Portable Thermal Block Module

The thermal block module of the present disclosure is not particularly limited in use outdoors and/or indoors, and is readily portable, preferably for on-site diagnostic use. According to one embodiment of the present disclosure, the total weight of the thermal block module may be about 50 to 200 grams, preferably about 80 to 150 grams, most preferably about 100 grams. The weight of the thermal block module of the present disclosure is 10 to 20 times less than the average weight of conventional commercially-available thermal block modules, which is 1 to 2 kilograms, and thus provides great convenience for a user to carry the thermal block module easily and use the thermal block module immediately in the field.

In addition, the thermal block module of the present disclosure is capable of stably maintaining a desired temperature even when used in the field, thereby achieving excellent precision and stable reproducibility in chemical and/or biological reaction experiments in the field, and furthermore, improving the reliability of experimental results, i.e., diagnostic results.

The present disclosure relates to a thermal block module, wherein the thermal block module includes a heating element, a heat block stacked on the heating element, the heat block including a substrate and one or more bodies, the one or more bodies being located on the substrate so as to be spaced apart from each other, each of the bodies including an insertion recess configured to allow at least a part of a reaction vessel to be inserted thereinto, each of the substrate and the bodies being made of a thermally conductive material, and a fixing unit.

Hereinafter, a further detailed description of the thermal block module will be given with reference to the accompanying drawings.

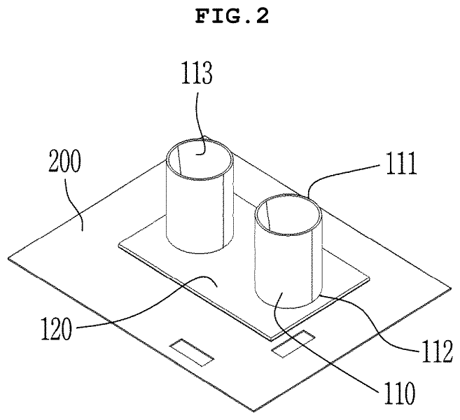

The thermal block module of the present disclosure includes a heating element. The heating element may heat a heat block, and the heat block may be heated to increase the temperature of a reaction vessel to a temperature suitable for analysis. In terms of portability, light weight, and volume minimization, according to one embodiment of the present disclosure, the heating element may be a planar heating element. The planar heating element may be provided in a form such as a thin substrate. As shown in FIG. 2, it is required for the heating element 200 to have sufficient area to provide reliable thermal energy while allowing the heat block 100 to be stacked stably thereon. According to one embodiment of the present disclosure, the area of the heating element may be greater than or equal to the area of the substrate of the heat block.

The planar heating element used in the present disclosure has excellent thermal efficiency and small heat capacity, whereby it is possible to provide sufficiently high thermal energy with low power unlike conventional heat blocks, and therefore the thermal block module of the present disclosure may be powered by a dry cell or a battery. According to one embodiment of the present disclosure, the thermal block module may be operated for about 200 to 400 minutes with an output of about 1 to 10 V from a dry cell or a battery. The temperature of the thermal block module may be controlled within a temperature range of about 25 to 130° C., and the actual drive time of the thermal block module may be shorter if the use time at higher temperatures is longer.

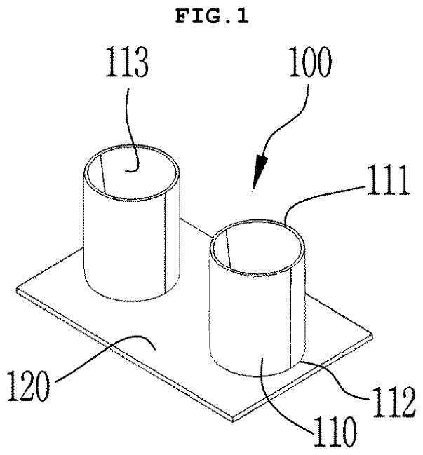

The heat block of the present disclosure includes a substrate and a body. In one embodiment of the present disclosure, the heat block may include a substrate and one or more bodies. Referring to FIG. 1, the heat block 100 includes a substrate 120 and one or more bodies 110, the bodies being in contact with the substrate and located on the surface of the substrate. Each of the bodies includes an insertion recess 113 configured to allow at least a part of a reaction vessel 400 to be inserted into the body therethrough.

In use, the reaction vessel is at least partially inserted into the insertion recess. Specifically, the part of the reaction vessel in which a reactant (or a sample) is located, typically a lower part of the reaction vessel, may be inserted into the insertion recess. According to one embodiment of the present disclosure, the insertion recess may be formed such that the lower part of the reaction vessel corresponding to about ¼ to ½ of the total length of the reaction vessel can be inserted into the insertion recess. The surface of the insertion recess may be in direct contact with the reaction vessel to transfer thermal energy of the body to the reaction vessel. Accordingly, the appearance of the insertion recess preferably matches the appearance of the lower part of the reaction vessel. For example, if the end of the lower part of the reaction vessel is conical, the insertion recess may be designed as a conical recess such that the maximum surface area of the insertion recess is in contact with the end of the lower part.

As shown in FIG. 1, an upper surface 111 and a lower surface 112 of the body may be parallel to each other, and may have the same diameter and width. The insertion recess may be formed in a direction from the upper surface to the lower surface. According to one embodiment of the present disclosure, the insertion recess may have a largest diameter at the position in the upper surface and a smallest diameter at the lowest position in the direction toward the lower surface. According to another embodiment of the present disclosure, the insertion recess may have the same diameter at the position in the upper surface and the lowest position in the direction toward the lower surface. The former embodiment is preferable from the point of view of enabling rapid analysis using a small amount of a reactant in the field.

The depth of the insertion recess in the direction from the upper surface to the lower surface is less than the length of the body. Here, the length of the body means the shortest length of the body between the upper surface and the lower surface. The depth of the insertion recess may be about 80% to less than 100% of the length of the body, preferably from 90% to 98%, more preferably 94% to 96%. The relationship between the depth of the insertion recess and the length of the body is preferably within the above numerical range from the point of view of heating to a more precise temperature and shortening of the heating time.

The length and diameter of the body may have sufficient sizes such that at least a part of the reaction vessel can be inserted into the insertion recess. According to one embodiment of the present disclosure, the body may have a length of about 5 to 10 mm and a diameter of about 3 to 10 mm, preferably a length of about 5 to 8 mm and a diameter of about 4 to 6 mm.

As shown in FIG. 1, the lower surface of the body is attached to the substrate. According to one embodiment of the present disclosure, the body and the substrate may be permanently fixed to each other by an adhesive or the like, or alternatively, the body and the substrate may be integrally formed. In addition, according to another embodiment of the present disclosure, the lower surface of the body may be fixed to the substrate only when in use, and may be detachable from the substrate.

The heat block of the present disclosure may include one or more bodies. In one embodiment of the present disclosure, the heat block may include 1 to 2000 bodies. Preferably, the number of bodies may be 2 to 1000, more preferably 2 to 500, most preferably 2 to 200. In another embodiment of the present disclosure, from the point of view of the use of 96 wells, the number of the bodies may be 96 such that all reaction vessels mounted in the 96 wells can be fixed in the bodies. Alternatively, the number of bodies may be 384 or 1536.

Having a number of bodies within the range is desirable for a portable thermal block module, and if the thermal block module has a number of bodies in excess of the range, the volume of the thermal block module may become excessively large and not suitable for portability.

Referring back to FIG. 1, when the heat block includes a plurality of bodies, in one embodiment of the present disclosure, the plurality of bodies may be located on the substrate in a state of being spaced apart from each other. In another embodiment of the present disclosure, unlike FIG. 1, the plurality of bodies may be located on the substrate in contact with each other. When the plurality of bodies is spaced apart from each other as shown in FIG. 1, it has the advantage of being easy to adjust the number of bodies in order to satisfy the needs of the user and to produce the bodies in large quantities, and furthermore, it is desirable in that it is not necessary to prepare a separate space for a sensor, a description of which will follow, to be installed from the point of view of the installation of the sensor. When the plurality of bodies is fixed in contact with each other, on the other hand, it may be advantageous in that the respective bodies are maintained at the same temperature in a single heat block through the conduction of heat supplied from the heating element between the bodies.

In the present disclosure, the substrate and the body may be made of the same material, or may be made of different materials. Preferably, the substrate and the body are made of the same material. In the present disclosure, each of the substrate and the body may be made of a thermally conductive material. In the present disclosure, “thermally conductive material” means a material having relatively high thermal conductivity that can be used to sufficiently transfer heat supplied from the heating element to the reaction vessel. The thermally conductive material may be a metal or an alloy. According to one embodiment of the present disclosure, the thermally conductive material may be silver, copper, gold, aluminum, an alloy including at least one thereof, or a composition thereof. The thermally conductive material of the present disclosure may be a material having a thermal conductivity of about 100 kcal/° C. or more. From the point of view of portability, cost, and durability, the thermally conductive material is preferably aluminum or an aluminum alloy.

In order to improve portability, the heat block of the present disclosure may be manufactured in a thin shape. Specifically, the substrate may have a thickness of about 0.1 to 1 mm. Preferably, the thickness of the substrate is about 0.2 to 0.5 mm, most preferably about 0.3 mm. In addition, the thickness of the thinnest part of each body, e.g., in the case of FIG. 1, the thickness of the body at the upper surface of the body may be about 0.1 to 1 mm. Preferably, the thickness of the portion is about 0.2 to 0.5 mm, most preferably about 0.3 mm. If the thickness is greater than this, the total weight of the thermal block module may increase, making use thereof as a thermal block module for on-site diagnosis difficult. Conversely, if the thickness is excessively small, durability of the thermal block module may be reduced, thereby increasing the likelihood that the heat block may be crushed or broken when mounting and removing the reaction vessel.

The heat block of the present disclosure is stacked on the heating element. Referring to FIG. 2, one or more bodies are stacked on one surface of the substrate of the heat block, and the opposite surface of the substrate, which is not in contact with the bodies, is in contact with the heating element 200. Consequently, thermal energy from the heating element may be transferred to the bodies and the reaction vessel via the substrate. According to one embodiment of the present disclosure, the heating element may include an electrode portion and a heating portion. Voltage supplied from the outside may be applied to the heating portion via the electrode portion. The heating portion generates heat using the voltage applied thereto. In order to improve portability, one surface of the heat block may be designed to directly contact only the heating portion of the heating element.

The thermal block module of the present disclosure may further include a sensor. The sensor may be a sensor capable of detecting temperature, pressure, humidity, gas, or the like. Considering the main function of the thermal block module provided in the present disclosure, the sensor is preferably a temperature sensor. In the case of on-site equipment, the sensitivity to the external environment is higher than in the case of an indoor laboratory, and therefore the temperature measured by single equipment varies depending on the position. It is obvious that the closer the sensor is installed to the heating element, the higher the temperature will be than in other cases. The inventors of the present disclosure have recognized that, when chemical and/or biological reaction experiments on a sample collected from a subject are conducted in the field, the potential for error and experimental failure due to such temperature differences is significant, and have noted the importance of sensor position. In the present disclosure, therefore, the sensor may be installed at the portion where the temperature substantially equal to the temperature of the reaction vessel that is actually heated can be measured. Specifically, the sensor may be located on the same surface of the substrate as the body in contact with the substrate. In one embodiment of the present disclosure where the heat block includes two or more bodies, the sensor may be located between the at least two bodies so as to be spaced apart from the bodies. In another embodiment of the present disclosure where the heat block includes four or more bodies, the sensor may be located spaced apart from the at least four bodies while maintaining the shortest distance from each of the bodies.

The thermal block module of the present disclosure may further include a sensor mounting hole. According to one embodiment of the present disclosure, the sensor mounting hole may be formed on the substrate of the heat block. In one example, the sensor mounting hole may be integrally formed with the body, and in another example, the sensor mounting hole may be integrally formed with the body and the substrate.

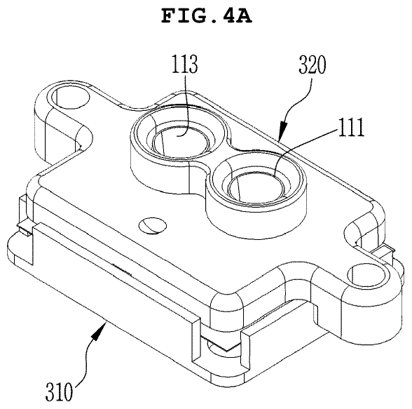

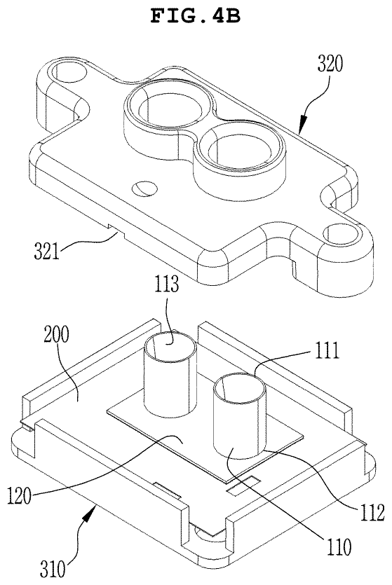

According to another embodiment of the present disclosure, the sensor mounting hole may not be pre-formed, but may be formed as a second fixing unit is stacked on the heating element and the heat block for use of the thermal block module. Referring to FIGS. 4A and 4B, it can be seen that, as the second fixing unit 320 is stacked on the heating element 200 and the heat block 100, the sensor mounting holes 321 are formed. In one embodiment of the present disclosure, the sensor mounting hole may be formed in the shape of a long narrow tube configured to guide the sensor to be installed and may extend to the space between at least two bodies. The sensor mounting hole may allow the sensor to be easily installed at the aforementioned position on the substrate. The temperature sensor of the present disclosure includes, but is not limited to, PT100 or PT1000. When using a thin sensor such as a wire thermocouple sensor, the sensor may be easily installed at the desired position without guidance of the tubular sensor mounting hole. It is possible to check the current temperature of the reaction vessel in real time through the temperature sensor installed as described above.

A single sensor mounting hole may be provided, or a plurality of holes may be provided in preparation for a test that is sensitive to various environmental conditions in on-site diagnosis.

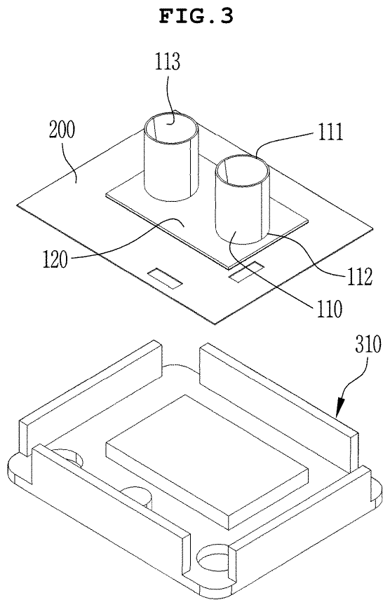

As shown in FIGS. 3, 4A, and 4B, the heating element and the heat block of the present disclosure may be stably fixed via a separate fixing unit 300 configured to surround the heating element and the heat block, rather than being directly fixed by an adhesive or the like. Direct fixation of the heating element and the heat block may avoid problems such as generation of harmful gases or dripping of the adhesive as the result of melting of the adhesive when thermal energy is supplied from the heating element.

The fixing unit may include a first fixing unit 310 and a second fixing unit 320. Referring to FIG. 3, the heating element and the heat block may be sequentially stacked on the first fixing unit. A part of the first fixing unit and a part of the second fixing unit may directly or indirectly contact each other to fix the heating element and the heat block between the first fixing unit and the second fixing unit. The part of the first fixing unit and the part of the second fixing unit may be engaged with each other in contact with each other, or may be fixed to each other in a coupled shape using a fixing member such as a screw or a bolt. Referring to FIG. 4, the second fixing unit is mounted above the heat block and has an opening through which the upper surface of the body may be exposed to the outside so as to allow mounting of a well and the reaction vessel to the heat block even after fixation. Preferably, the fixing unit minimizes the exposure of the heat block and the heating element to the outside, excluding the opening, to minimize heat loss.

The fixing unit is preferably made of a material having heat resistance, by which the fixing unit is not deformed by heat generated by the heating element, and at the same time having light weight suitable for portability. In one embodiment of the present disclosure, the fixing unit may be made of heat-resistant plastic. In the present disclosure, the fixing unit may be made of PEEK, PC, or a combination thereof.

The thermal block module of the present disclosure may further include a reaction vessel. The reaction vessel is not particularly limited as long as at least a part of the reaction vessel is inserted into the insertion recess of the body of the heat block and the reaction vessel does not interfere with heating and reaction of a sample contained in the reaction vessel as an on-site, portable analysis device. According to one embodiment of the present disclosure, the reaction vessel 400 may be a reaction tube. At least a part of the reaction vessel may be inserted into the insertion recess of the body covered by the second fixing unit from above. When two or more reaction vessels are inserted into the thermal block module, a fixing frame may be used to allow the two or more reaction vessels to be inserted into the respective bodies of the thermal block module at one time. In addition, when 10 or more reaction vessels, e.g., 20 or more reaction vessels, 50 or more reaction vessels, or 100 or more reaction vessels, are inserted into the thermal block module, a well having an appropriate size may be used to allow the plurality of reaction vessels to be inserted into the respective bodies of the thermal block module at one time.

The thermal block module of the present disclosure as described above is easily portable and enables a diagnostic test requiring precise temperature control to be performed directly on site, whereby it is possible to provide superior advantages to conventional thermal block modules in terms of convenience and reliability.

### Temperature Variable System/Module for Reaction Vessels

The present disclosure provides a temperature variable system (or module) capable of rapidly varying the temperature of a reaction vessel utilizing the aforementioned thermal block module. In chemical or biological experiments requiring a plurality of different reaction temperature zones, heating the temperature of the heat block to a first temperature and then changing the temperature of the heat block to a second temperature different from the first temperature using a conventional thermal block module causes an inevitable delay. In addition, physically moving the reaction vessel by the user using a plurality of conventional thermal block modules may not only cause a risk of burns, but may also reduce reliability of experimental results due to impact on the reaction vessel during movement, time consumption, etc.

Accordingly, the present disclosure provides an on-site temperature variable system for reaction vessels including the thermal block module of the present disclosure that can solve the above problems.

The temperature variable system of the present disclosure includes a thermal block module, a support unit; a chamber unit, and a rotating shaft. The temperature variable system includes two or more thermal block modules. The portable thermal block module of the present disclosure described above is used as the thermal block module. In one embodiment of the present disclosure, the temperature variable system may include 2 to 10 thermal block modules. From the point of view of portability and light weight, the temperature variable system may include 2 to 6 thermal block modules, more preferably 2 to 4 thermal block modules. In the plurality of thermal block modules, the temperatures of the first thermal block module and the second thermal block module may be different from each other. In one embodiment of the present disclosure, the temperature difference between the first thermal block module and the second thermal block module may be about 10° C. or more.

The thermal block module is supported by the support unit. The thermal block module may be located spaced apart from a lower housing of an analysis device via the support unit. The support unit includes a support plate, and the plurality of thermal block modules included in the temperature variable system is fixed to one surface of the support plate. According to one embodiment of the present disclosure, the support plate may include a plurality of recesses formed so as to be engaged with the first fixing unit of each of the plurality of thermal block modules such that the thermal block module can be stably fixed. In addition, the rotating shaft, a description of which will follow, may extend to the chamber unit through the support plate, and the rotating shaft and the support plate may be connected to each other such that the support plate moves upward and downward while remaining horizontal as the rotating shaft rotates at the position where the rotating shaft extends through the support plate. When the rotating shaft rotates in one direction, therefore, the support plate may move downward to separate the reaction vessel from the thermal block module, and when the rotating shaft rotates in the opposite direction, the support plate may move upward to insert the reaction vessel mounted in the chamber unit into the thermal block module.

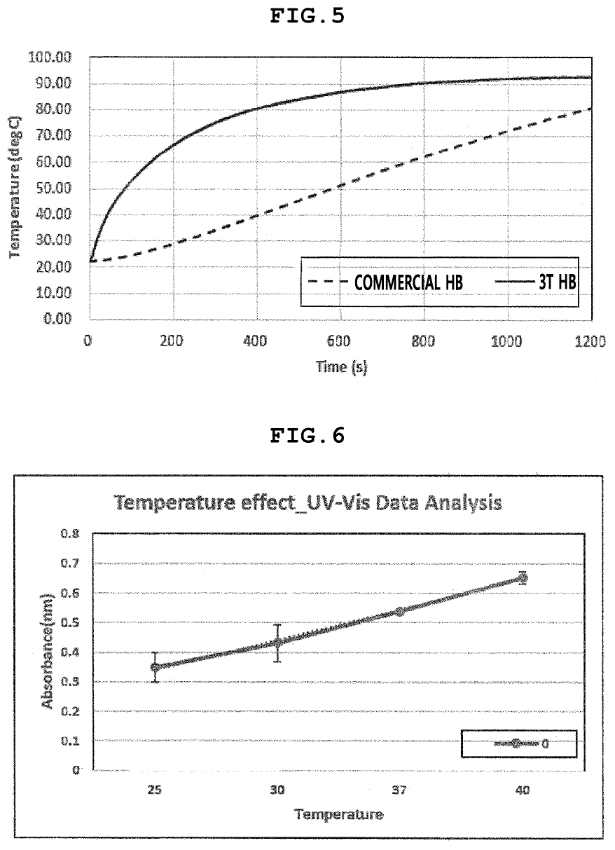

A set of reaction vessels may be mounted in the chamber unit. A set of reaction vessels is fixed in a state of extending through one surface of the chamber unit. The part of the reaction vessel exposed on the opposite surface of the chamber unit after extending through the chamber unit may be inserted into the insertion recess of the heat module block and may be heated to a preset temperature. Here, a set of reaction vessels is a group of reaction vessels that can be simultaneously inserted into one thermal module block, and in the present disclosure, a set of reaction vessels includes a plurality of reaction vessels. In FIG. 5, two reaction vessels constitute a set of reaction vessels; however, the present disclosure is not necessarily limited thereto. For example, a set of reaction vessels may include 2 to 2000 reaction vessels, such as 2, 4, 6, 8, 10, 20, 30, 40, 50, 100, 200, 300, 400, 500, 1000, or 2000 reaction vessels. In one example, a set of reaction vessels may include 96, 384, or 1536 reaction vessels.

In the present disclosure, the number of reaction vessels constituting a set of reaction vessels may be less than or equal to the number of bodies of one thermal block module, and preferably the number of reaction vessels constituting a set of reaction vessels is equal to the number of bodies of one thermal block module.

According to one embodiment of the present disclosure, the temperature variable system may include a plurality of chamber units. When the temperature variable system includes a plurality of chamber units, the number of the chamber units may be equal to or less than the number of a plurality of thermal block modules included in the temperature variable system.

The chamber unit is connected to the rotating shaft such that the chamber unit rotates in the same direction as the rotating shaft rotates in one direction. However, the chamber unit is connected to the rotating shaft such that the chamber unit does not rotate when the rotating shaft rotates in the opposite direction. One end of the rotating shaft may be connected to the chamber unit.

The rotating shaft may include a motor, which may be driven by power supplied from an external power source to rotate the shaft in both directions, such as one direction and the opposite direction. As the rotating shaft rotates in one direction, the support unit moves downward and the chamber unit rotates in the same direction as the rotating shaft, and as the rotating shaft rotates in the opposite direction, the support moves upward, whereby the reaction vessel mounted in the chamber unit comes into contact with the thermal block module.

When the temperature variable system includes a plurality of thermal block modules, the reaction vessel may be physically moved from a first thermal block module to a second thermal block module and from the second thermal block module to a third thermal block module as in the manner described above. At this time, the time required to move the reaction vessel from the first thermal block module to the second thermal block module may be about 5 seconds or less, preferably 3 seconds or less, most preferably 2 seconds or less.

The temperature variable system of the present disclosure may further comprise a rotation guide unit. The rotation guide unit is located between the support unit and the chamber unit and serves to guide rotation of the chamber unit. Specifically, the rotation guide unit may only allow rotation in one direction and prevent rotation in the opposite direction when the chamber unit is rotated in response to rotation of the rotating shaft. In addition, the rotation guide unit serves to guide movement of a set of reaction vessels mounted in the chamber unit so as to be moved directly over the insertion recess of the second thermal block module when moved from the first thermal block module to the second thermal block module.

The temperature variable system of the present disclosure may further include a fixing unit. One end of the fixing unit may be fixed to the lower housing of the analysis device and the other end of the fixing unit may be fixed to the rotation guide unit, whereby the temperature variable system may be stably fixed in the analysis device. The shape of the fixing unit is not particularly limited as long as the fixing unit is capable of stably fixing the temperature variable system.

As the temperature variable system (or module) of the present disclosure described above includes a portable thermal block module that is designed to be lightweight, it is possible to achieve easy portability and to minimize the temperature transition time during which the temperature changes from a first temperature to a second temperature different from the first temperature, even in experiments requiring a plurality of reaction temperature zones, and therefore it is possible to provide superior advantages to conventional thermal block modules in terms of convenience and reliability.

Analysis device including thermal block module and/or temperature variable system

The present disclosure provides an on-site analysis device including the portable thermal block module and/or the temperature variable system for reaction vessels. The on-site analysis device includes a power supply unit, a control unit, a driving unit, and a display unit. The analysis device may be constituted by a lower housing, an upper housing, and a cover. The thermal block module or the temperature variable system of the present disclosure may be installed in the space between the upper housing and the lower housing, and the power unit may be installed in the space. Preferably, the power supply unit is a disposable/multi-use battery or a rechargeable built-in battery from the point of view of on-site diagnostic use.

A recess is provided in a part of the upper housing, and it is possible to mount a reaction vessel containing a sample from the outside in the thermal block module or the temperature variable system through the recess. The upper housing may include the display unit and the control unit. From the point of view of light weight, it is preferable to integrate the display unit and the control unit into a touchscreen.

The control unit may set the temperature of the thermal block module, the time during which the reaction vessel is located in each thermal block module, the number of cycles, and the like, and may start/stop the analysis device.

The display unit may display the values set by the control unit and the progress.

The cover prevents contact between the reaction vessel and the external environment after the reaction vessel is mounted in the device and contributes to minimizing heat loss in the analysis device.

The analysis device of the present disclosure may further include one or more fans. The analysis device, the temperature variable system, and the thermal block module of the present disclosure are characterized in that no separate refrigerant or cooling system is required. The heat block of the present disclosure allows for the omission of a refrigerant, and cooling of the thermal block module may be accomplished by only contact with air without heating, and the presence of the fans functions to further facilitate the circulation of air. Omission of the refrigerant and the cooling system including the refrigerant further contributes to reduction in weight of the thermal block module, the temperature variable system, and the analysis device of the present disclosure, which may significantly improve suitability of the technology of the present disclosure for use in the field.

Hereinafter, a preferred embodiment of the present disclosure will be presented to facilitate understanding of the present disclosure; however, the following embodiment is provided for easier understanding of the present disclosure, and the present disclosure is not limited thereto.

### EXAMPLE

### Experimental Example 1

A thermal block module of the form shown in FIGS. 1 to 4 was manufactured. A carbon nanotube heating element was applied to a polyimide substrate, and after drying, a copper wire was connected to form a planar heating element. Aluminum was used as the material of a heat block, and the thickness of each of the thinnest part of a body of the heat block and the substrate was about 0.3 mm. A battery of about 4.15 V was used as a power source for the thermal block module.

For comparison, a commercially available heat block (BF_20HB, manufactured by BioFree) was prepared. The commercial heat block was operated under the conditions of 100 W and 220 V.

The target temperature of each of the thermal block module of the present disclosure and the commercially available conventional heat block was set to 92° C. and the time taken to reach the target temperature was measured. The temperature rise graphs of the two heat blocks over time are shown in FIG. 5.

Referring to FIG. 5, it can be seen that the temperature reached 92° C. in about 14 minutes when the heat block of the present disclosure was used. In the commercial heat block, on the other hand, it took about 25 minutes to reach 92° C. This shows that the thermal block module of the present disclosure exhibits better performance than the conventional heat block while being portable.

### Experimental Example 2

Activity and reproducibility of a biological reaction in which a temperature of 30° C. or higher is the optimal reaction temperature was tested using the same thermal block module of the present disclosure as the thermal block module manufactured in Experimental example 1.

A redox reaction by HRP was used as the biological reaction. Streptavidin (STV) was fixed to the surface of a well, biotin-labeled horseradish peroxidase (HRP) was fixed thereto, H2O2 and TMB treatment was carried out, and the redox reaction by HRP was performed under various temperature conditions of 25 to 40° C., and absorbance as a function of the reaction was measured using a UV-Vis spectrometer.

The absorbance results as a function of temperature are shown in FIG. 6. The biological reaction is known to have a temperature of 37 to 40° C. as the optimum reaction temperature, and referring to FIG. 6, it can be seen that the absorbance increased at a higher temperature than room temperature, and it can also be seen that the reaction had relatively high reproducibility at a temperature of 37° C. or higher (see the widths of temperature-specific vertical bars in FIG. 6). The reproducibility was calculated as CV %=14.00 at 25° C., CV %=14.43 at 30° C., CV %=1.13 at 37° C., and CV %=3.14 at 40° C., and it can be seen that the reproducibility value was 10 times higher at a temperature of 37° C. or higher than at temperatures therebelow.

From the above results, it can be seen that, in a situation where a diagnostic test through a biological or chemical reaction having the optimum reaction temperature at a temperature higher than room temperature is required, there is a problem that reliability and accuracy of the test are low due to low reproducibility and low reaction activity if the test is performed in the field without any temperature control, but when the thermal block module of the present disclosure is used, it is possible to achieve high reaction activity and reproducibility by controlling the temperature of the well mounted in the thermal block module so as to have the optimum reaction temperature, thereby making it possible to perform the diagnostic test in the field quickly and conveniently.

### Experimental Example 3

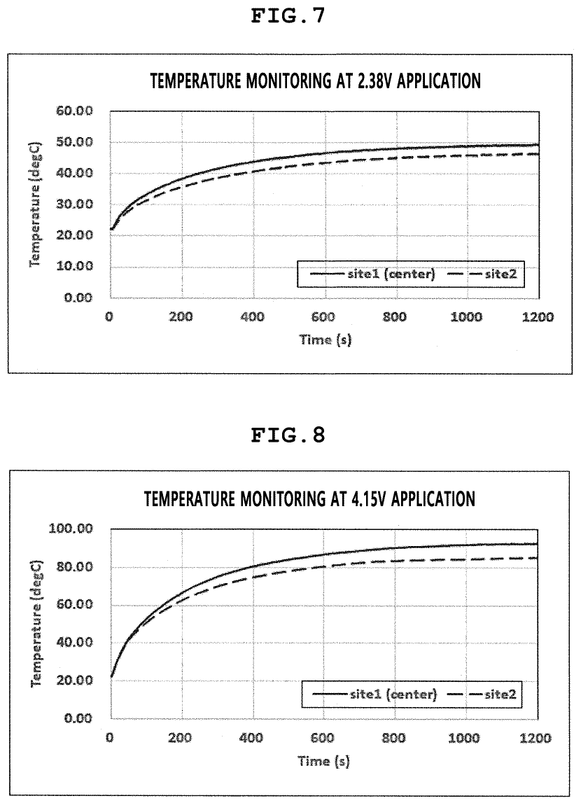

After fixing a temperature sensor at different positions on the substrate of the heat block, the thermal block module was operated with a constant voltage applied thereto to measure the temperature change of the sensor over time outdoors. The measured results are shown in FIGS. 7 and 8. Here, site 1 indicates the center of the surface of a rectangular substrate (two bodies being present in the vicinity of the center and the sensor being located at equally spaced distances from the bodies), and site 2 indicates the periphery of the substrate (only one body being located in the vicinity of the periphery).

Referring to FIGS. 7 and 8, it can be seen that the difference in time-specific temperatures measured at site 1 and site 2 is significant. Without wishing to be limited to a specific theory, it is thought that the difference in temperatures is not only due to conduction of heat from the substrate but also due to convection of heat from the body of the heat block surrounding the sensor. In on-site analysis, which is sensitive to the effects of the ambient environment, the temperature difference is expected to cause analysis failure due to cessation of experiments in an insufficient state, excessive experiment time, and the like. Accordingly, it is anticipated that installing the sensor at the position described above in the present disclosure may contribute to minimizing the likelihood of such analysis failures by enabling checking of a temperature that is substantially the same as the current temperature of the actual reaction vessel.

All simple variations or modifications of the present disclosure are within the scope of the present disclosure, and the specific scope of protection of the present disclosure will be made clear by the appended claims.

What is claimed is:

1. A portable thermal block module comprising:
a heating element;
a heat block stacked on the heating element, the heat block comprising a substrate and one or more bodies, the one or more bodies being located on the substrate so as to be spaced apart from each other, each of the bodies comprising an insertion recess configured to allow at least a part of a reaction vessel to be inserted thereinto, each of the substrate and the bodies being made of a thermally conductive material; and
a fixing unit.

2. The portable thermal block module according to claim 1, wherein the heating element comprises a planar heating element.

3. The portable thermal block module according to claim 1, wherein the heat block comprises 1 to 2000 bodies.

4. The portable thermal block module according to claim 1, wherein each of a thinnest part of each body and the substrate has a thickness of 0.1 mm to 1 mm.

5. The portable thermal block module according to claim 1, further comprising a sensor,
in response to the heat block comprising two or more bodies, the sensor is configured to be located on the substrate between the at least two bodies so as to be spaced apart from the bodies.

6. The portable thermal block module according to claim 1, wherein:
the fixing unit comprises a first fixing unit and a second fixing unit, and
a part of the first fixing unit and a part of the second fixing unit directly or indirectly contact each other to fix the heating element and the heat block between the first fixing unit and the second fixing unit.

7. A temperature variable system for reaction vessels, the temperature variable system comprising:
two or more thermal block modules, each of the thermal block modules being the portable thermal block module according to claim 1;
a support unit configured to support the thermal block modules;
a chamber unit configured to allow a set of reaction vessels to be mounted therein, the set of reaction vessels comprising a plurality of reaction vessels, the number of the reaction vessels being less than or equal to the number of the bodies of one of the thermal block modules; and
a rotating shaft, the rotating shaft being connected to the support unit and the chamber unit such that, when the rotating shaft rotates in one direction, the support unit moves downward and the chamber unit rotates, and when the rotating shaft rotates in the opposite direction, the support unit moves upward.

8. The temperature variable system according to claim 7, further comprising a rotation guide unit connected to the rotating shaft and the chamber unit, the rotation guide unit being configured to guide rotation of the chamber unit.

9. An on-site analysis device comprising the portable thermal block module according to claim 1.

10. An on-site analysis device comprising the temperature variable system for reaction vessels according to claim 7.
